(19) United States
(12) Patent Application Publication
(10) Pub. No.: US 2009/0146080 A1
(43) Pub. Date: Jun. 11, 2009

(54) METHOD AND MEASURING SYSTEM FOR DETERMINING THE OXYGEN PARTIAL PRESSURE DISTRIBUTION IN AT LEAST ONE TISSUE SURFACE SECTION, IN PARTICULAR SKIN TISSUE SURFACE SECTION

(76) Inventor: Gregor Liebsch, Obertaubling (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/989,525

(22) PCT Filed: Jun. 14, 2006
(86) PCT No.: PCT/DE2006/001031

§ 371 Date: Jan. 28, 2008

(30) Foreign Application Priority Data
Jul. 29, 2005 (DE) 10 2005 036 410.1

(51) Int. Cl. H05B 33/00

(52) U.S. Cl. 250/484.4

(57) ABSTRACT

To determine the oxygen partial pressure distribution in at least one tissue surface section, a fluorescent dye is applied to the tissue surface section, which is impinged with excitation light in order to generate fluorescence. In the rise phase of the fluorescence, at least one first fluorescent image is taken by means of a camera system and in the fall phase of the fluorescence at least one second fluorescent image is taken. Subsequently, the fluorescent intensities in the rise and fall phase are determined based on the first and second fluorescent images taken and, by a ratio formation of the determined fluorescent intensities, the oxygen partial pressure distribution in the at least one tissue surface section is determined.

### BACKGROUND OF THE INVENTION

The invention relates to a method for determining the oxygen partial pressure distribution in at least one tissue surface section, in particular a skin surface section.

The primary task of small vessels within the tissue surface section is to supply the tissue with oxygen. Although this supply of oxygen is sufficient, the oxygen content can be determined by a selective measurement at different tissue locations or a measurement of the oxygen partial pressure in the tissue. Methods for the selective measurement of the oxygen content at different tissue locations are known in the art and are based on resistance measurements by means of so-called Clark electrodes. Measurements of the oxygen partial pressure in a tissue surface section are conducted by means of transcutaneous oxygen measurements (TCPO₂). The results of the measurement make it possible, for example, to assess the therapeutic success of treatments or the critical degree of hazard to individual bodily extremities.

In known measuring systems based on the principle of transcutaneous oxygen measurement, fluorescent optical sensors designed as gas sensors are used to measure the current oxygen partial pressure in the tissue instead of the absolute number of oxygen molecules. This makes it possible to quantify the effect of oxygen on a fluorescent optical sensor based on the measured oxygen partial pressure. The ambient air pressure in the measuring environment and the prevalent temperature are taken into account in such measurements.

A fluorescent optical sensor, designed as a gas sensor, is constructed, for example, as a planar oxygen sensor, which is applied to the surface of the tissue section that has been pre-treated with a corresponding emulsion or special fluid. This creates a measuring environment that reflects the tissue properties between the planar oxygen sensor and the tissue surface. The fluorescent dye molecules of the fluorescent optical sensor are in an excited state and when exposed to excitation light they either release their energy into the environment in the form of fluorescent emission light or transmit it “without radiation” to an oxygen molecule in the measuring environment. The latter case is also referred to as “dynamic fluorescent quenching”, in which the degree of quenching depends on the oxygen partial pressure in the medium.

The described principle of dynamic fluorescent quenching is used for determining the oxygen partial pressure by measuring the intensity of fluorescence generated under continuous illumination and also its fall time or “lifetime”, namely by taking one or more fluorescent images. The fall time is the duration for which the fluorescent dye persists after the excitation light used to generate the fluorescence has been switched off. The fluorescent intensity and its lifetime provide information on the oxygen partial pressure in the tissue. For example, an increase in the oxygen partial pressure reduces the lifetime of the fluorescence.

The use of such a fluorescent intensity measurement for determining the oxygen partial pressure in a tissue section has several disadvantages, especially on uneven tissue surfaces. The dependence of the fluorescent intensity on the number of dye molecules contained in the photographed segment, the intensity of the excitation light and the oxygen partial pressure in the tissue results in various interfering factors that are difficult to isolate. A calibration and/or correction of the measurement is therefore nearly impossible, especially when the fluorescent optical sensors are implemented in the form of micro-particles, in which a homogeneous distribution of the fluorescent dye molecules especially on the uneven skin surface cannot be assured.

Even assuming an ideal homogeneous dye distribution and an ideal homogeneous excitation of the fluorescent optical sensor, the unevenness in the tissue surface results in intensity patterns that in no way are based on oxygen partial pressure changes, but instead on virtually increased indicator concentrations in the individual sections of the tissue surface. This means that more dye molecules are measured per surface segment, which results in increased fluorescent intensity in the respective segments.

A further disadvantage of the fluorescent intensity measurement is caused by the use of transparent fluorescent optical sensors on optically heterogeneous surfaces, which absorb and/or reflect the incident light radiation differently at different locations. This can result in improved or diminished excitation efficiency in individual cases. The excitation light reflected by the surface is conducted through the sensor a second time, while the absorbed excitation light passes through the sensor only once. This results in a non-referenceable measuring error, which is due to the surface condition of the tissue surface section.

Furthermore, systems for fluorescent diagnostics are known in the art, which make use of the metabolic differences for example in the porphyrin metabolism between cells in dysplastic/tumorous tissue and cells in normal tissue. DE 101 57 575 A1, for example, discloses a system for visualization of fluorescent dyes for fluorescent diagnostics, in which at least one light source is used to impinge an observation area with excitation light and an optical detector is used to measure the fluorescent emission generated due to the fluorescent dye in the tissue. The optical detector in this system consists of at least one camera system for generating a normal image and a fluorescent image of the observation area. The at least one light source is designed as a pulsed light source, which is in the visible or infrared/UV range. The fluorescent image and the normal image of the entire observation area are consecutively detected, digitalized and processed in a computer unit. This makes it possible to display both images directly next to each other or one above the other on the monitor in order to view the affected tissue areas without loss of information contained in the color image, or normal image. This enables an improved and more conclusive fluorescent diagnosis.

It is an object of the invention is to provide a method and a measuring system that enable the measurement of planar oxygen partial pressure distributions in at least one tissue surface section.

### SUMMARY OF THE INVENTION

An essential aspect of the method according to the invention for determining the oxygen partial pressure distribution in at least one tissue surface section, in particular a skin surface section, is that a fluorescent optical sensor comprising a fluorescent dye is applied to the tissue surface section and the fluorescent dye applied to the tissue surface section is impinged with excitation light to generate fluorescence. In the rise phase of the fluorescence at least one first fluorescent image is taken by means of a camera system and in the fall phase of the fluorescence at least one second fluorescent image is taken; subsequently, the fluorescent intensities in the rise phase and fall phase are determined based on the first and second fluorescent images taken and, by a ratio formation of the fluorescent intensities determined, the oxygen partial pressure distribution in the at least one tissue surface section is determined. The advantage of this method is that it enables, also under room light conditions, a dimensional visualization of the oxygen distribution in a tissue surface section by analyzing the prevailing oxygen partial pressure distribution. Due to the ratio formation, the measurement is conducted independent of interfering factors that lead to measuring errors and is also possible in “live image mode” by fast control of the camera system and analysis of the digitalized image data obtained. Furthermore, a color image can be made of the tissue surface section to be measured and this image can be superimposed or put into relation with the first and/or second fluorescent image in order to quickly and reliably provide a more exact localization of damaged tissue areas.

### BRIEF DESCRIPTION OF THE DRAWINGS

The invention is described in more detail below based on an exemplary embodiment with reference to the drawings, in which:

FIG. 1 is a schematic representation of a measuring system for determining the oxygen partial pressure distribution in at least one tissue surface section;

FIG. 2 is a plan view of the top side of the measuring head unit of the measuring system of FIG. 1;

FIG. 3a,b are diagrams of the rise and fall time of the fluorescence for different oxygen partial pressures;

FIG. 4a,b are diagrams of the control signals provided for taking the first fluorescent image in the rise phase;

FIG. 5a,b are diagrams of the control signals provided for taking the second fluorescent image in the fall phase;

FIG. 6 is a visualization of the fluorescent intensity distribution in the rise phase based on an on-screen display and a profile plot;

FIG. 7 is a visualization of the fluorescent intensity distribution in the fall phase based on an on-screen display and a profile plot; and

FIG. 8 is a visualization of the proportional distribution based on an on-screen display and a profile plot.

### DETAILED DESCRIPTION OF THE INVENTION

FIG. 1 shows a schematic block diagram of a measuring system 1 for determining the oxygen partial pressure distribution in at least one tissue surface section. The measuring system 1 comprises a measuring head unit 2, a control unit 3 and a computer unit 4. The control unit 3 is connected with the measuring head unit 2 and the computer unit 4. For the graphic display of the measuring results, the computer unit 3 comprises at least one monitor unit 5.

The measuring head unit 2 includes, for example, a holding plate 6, which is provided for holding light sources 7 and at least one camera system 8. The light sources 7 are preferably designed as pulsed light sources 7, which are designed as LEDs, flash lamps, e.g. Xenon high pressure lamps, or laser diodes or laser diode arrays.

A fluorescent-optical sensor 10 is applied to the tissue surface section 9, preferably human or animal tissue surface section, after the application of a transparent emulsion or special fluid to the tissue surface section 8 to be examined in order to open the skin pores between the tissue surface section 9 and the fluorescent optical sensor 10. This creates optimum measuring conditions in the area between the tissue surface section 9 and the fluorescent optical sensor 10. The fluorescent optical sensor 10 is designed for example as a planar sensor film or as a micro-particle sensor and preferably has a red coloration. Further, said sensor is transparent and consists of a plurality of fluorescent dye molecules. A transcutaneous oxygen measurement is achieved by means of the fluorescent optical sensor 10 based on the principle of dynamic fluorescent quenching.

The camera system 8 is placed perpendicular at a distance d of 3-15 cm above the tissue surface section 9 to be measured and comprises for example a CCD module 11 (charge-coupled device) as an opto-electric image converter. Further, the camera system 8 is connected to the control unit 3 of the measuring system 1.

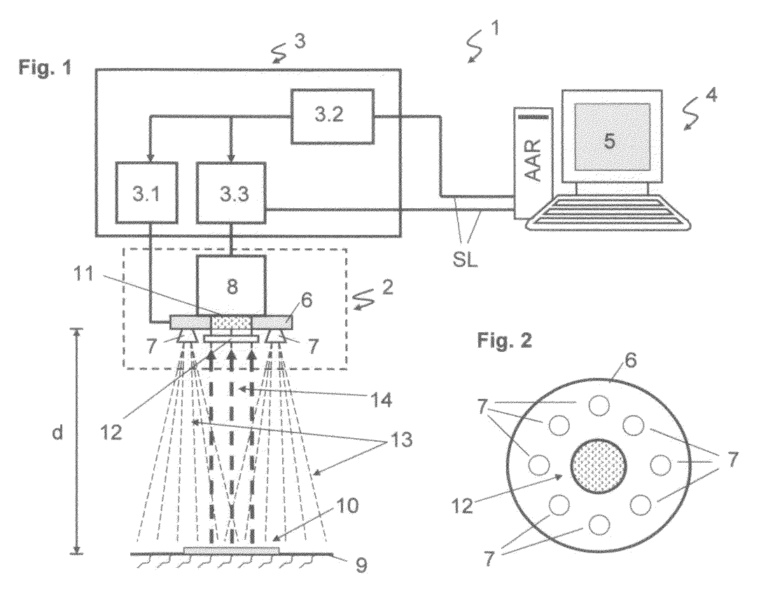

FIG. 2 shows a plan view of the front side of the measuring head unit 2 facing the measured object in operation; the lens 12 of the CCD module 11 is shown in the middle of the holding plate 6. Several light sources 7 preferably designed as LEDs are arranged around the lens 12 of the CCD module 11, for example symmetrically distributed around the lens 12, so that a nearly even illumination of the tissue surface section 9 to be measured is achieved.

This allows control of the light intensity required to generate the fluorescence by varying the number of light sources 7. Several such light sources 7 can be combined to form light source groups (not depicted in FIG. 2), which likewise are arranged symmetrically around the lens 12. In a preferred embodiment such a light source group is equipped with ca. 20-30 LEDs. Four or more such light source groups can be provided in one measuring head unit 1, so that a total of 80 to 120 LEDs, preferably 96 LEDs, are available for excitation of the fluorescence in the fluorescent optical sensor 10. The number of LEDs depends on the required luminous power. If LEDs with a high luminous power are used, for example, then the number of LEDs in each light source group can be reduced significantly.

The light sources 7 designed as LEDs can be controlled by means of pulsed control signals, which enable switching flanks in the range of 21 =100 ns. If fluorescent optical sensors 10 with porphyrins are used as the fluorescent dye, with a maximum absorption for the fluorescent excitation in the blue spectral range (ca. 405 nm) and with a maximum fluorescent emission in the red spectral range (ca. 630 nm), the light sources 7 for the excitation are so-called “blue” LEDs, which operate in the UV range. In addition to the “blue” LEDs, “white” LEDs can also be provided in the holding plate 6 for improved illumination of the tissue surface section 9 to be examined during the taking of additional color images.

The excitation light 13 generated by the pulsed light sources 7 is applied to the fluorescent-optical sensor 10 placed on the tissue surface section 9 to be examined. The excitation light 13 preferably impinges the fluorescent optical sensor 10 perpendicularly. The emission light 14 generated by the fluorescent optical sensor 10 is measured in the measuring head unit 2 via the CCD module 11 of the camera system 8 and is converted into an electric image data signal.

For control of the pulsed light source(s) 7, a light source control module 3.1 is provided in the control unit 3 and is connected with a trigger signal unit 3.2 also provided in the control unit 3. Additionally, the control unit 3 comprises a camera control module 3.3 that is likewise connected with the trigger signal unit 3.2 and that is provided for control of the camera system 8 and of the CCD module 11. The trigger signal unit 3.2 and the camera control module 3.3 are connected with the computer unit 4 via control lines SL. A control and analysis routine AAR is provided in the computer unit 4 for analysis of the measured data received by the control unit 3, for example in the form of digitalized images. Controlled via the control and analysis routine AAR, a square wave trigger signal ts is generated in the trigger signal unit 3.2, which (signal) is simultaneously sent to the light source control module 3.1 and the camera control module 3.3.

The light sources 7 are controlled by means of the light source control module 3.1 based on the trigger signal ts, so that an excitation light pulse with a length of ca. 100 μs is generated, with which the tissue surface section 9 to be examined is impinged. The taking of the fluorescent images is also triggered by the trigger signal ts, namely by means of the camera control module 3.3, which controls the camera system 8 and the CCD module 11 based on the trigger signal ts. In a preferred embodiment, normal images (RGB images) are taken via the camera system 8 in addition to fluorescent images, alternating with the fluorescent images, for example in a rhythm of 2:3, i.e. a first and second fluorescent image FB1, FB2 are first taken consecutively, followed by a first through third normal image NB1-NB3.

In a preferred embodiment, the exposure time of the fluorescent images corresponds to the excitation duration and is therefore likewise ca. 100 μs. On the other hand, the exposure time chosen for a normal image can be variable, preferably between 5 and 30 ms. Therefore, the image recording frequency for the normal images is, for example ca. 33.33 Hz and for the fluorescent images accordingly ca. 6.7 Hz.

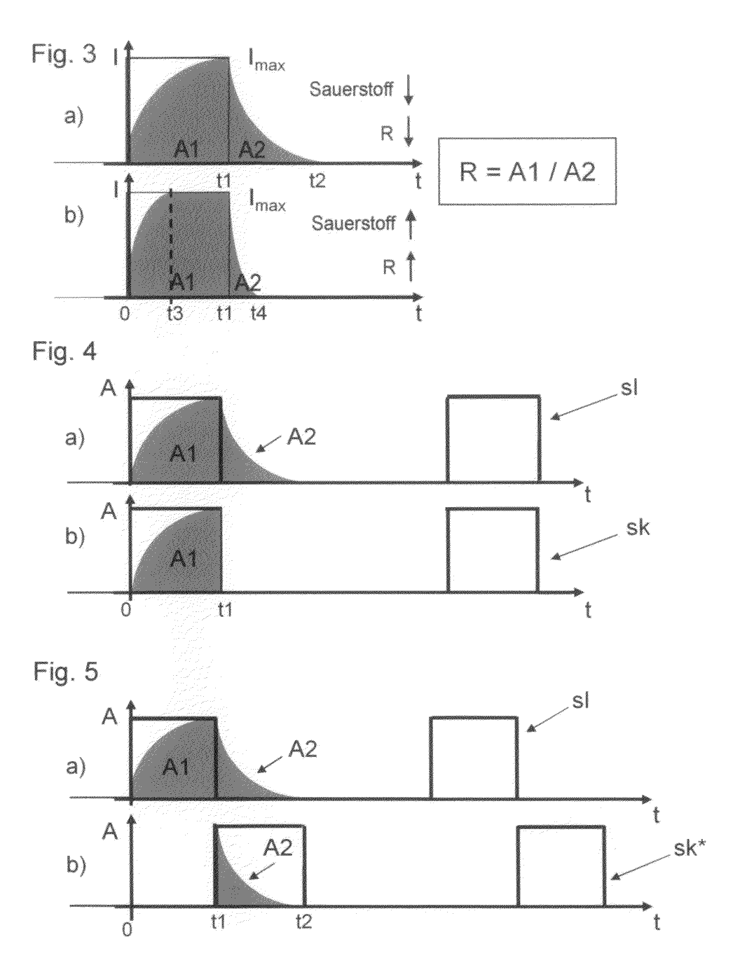

FIGS. 3a and 3b show the course of the intensity I of the emission light 14 and of the generated fluorescence for a first and second oxygen partial pressure P1, P2 over the time t. The fluorescent optical sensor 10 is impinged with excitation light 13 over an excitation duration continuing from a time t=0 to a first time t1 and the intensity I of the fluorescence over the time t is determined. Depending on the oxygen concentration and the first and second oxygen partial pressure P1, P2 in the tissue surface section 9 to be examined, the rise and fall phase AnP, AbP of the fluorescence is reduced. The rise phase AnP refers to the duration required from the excitation of the fluorescence until a saturation value Iₘₐₓ is reached and the fall phase AbP refers to the duration required for the saturation value Iₘₐₓ to fall to zero after switching off the excitation light 13.

At a low oxygen concentration and therefore a low first oxygen partial pressure P1 (FIG. 3a), the rise phase AnP continues over the entire excitation duration until the first time t1. Likewise, this results in a relatively long fall phase AbP, which continues from the first time t1 to a second time t2. FIG. 3b shows the course of the intensity I of the fluorescence for an increased oxygen concentration and a second oxygen partial pressure P2, which has considerably shorter rise and fall phases AnP, AbP as compared with the course shown in FIG. 3a. The rise phase AnP continues in the depicted embodiment from the first time t=0 to a third time t3, at which the saturation value Iₘₐₓ is reached and maintains the saturation value Iₘₐₓ through the first time t1, at which the excitation light is switched off. After switching off the excitation light 13 at the first time t1, the fall phase AbP begins and continues until a fourth time t4, which occurs considerably earlier than the second time t2.

By forming a first intensity integral A1 over the excitation duration from t=0 to t=t1 and a second intensity integral A2 over the fall phase AbP or the fall duration from t=t1 to t=t2 or t3, the fluorescent behavior depending on the existing oxygen partial pressure distribution can be quantified. To achieve this, the first and second intensity integrals A1, A2 are derived from the digitalized image data of the first and second fluorescent images FB1, FB2 and the following ratio R is determined from the derived first and second intensity integral A1, A2 for elimination of interfering factors:

R=A1/A2

The determined ratio R exhibits a direct proportionality to the oxygen partial pressure distribution in the tissue surface section 9 to be examined and an inverse proportionality to the fall duration of the fluorescence.

FIG. 4a shows a first control signal sl provided for control of the light sources 7 and FIG. 4b shows a second control signal sk provided for controlling the camera system 8, both in relation to the course of the intensity I of the fluorescence. The first and second control signal sl, sk are preferably designed as periodic square wave signals with an amplitude A, the phase position of which is triggered by the trigger signal ts. Both the first and the second control signal sl, sk receive the amplitude A at time t=0 and fall back to zero at time t1. The images taken by the camera system 8 are controlled by the second control signal sk and a first fluorescent image FB1 is generated in the rise phase AnP of the fluorescence.

To take a second fluorescent image FB2 in the fall phase AbP of the fluorescence the phase of the control signal sk depicted in FIG. 4b is shifted by an phase shift of 100 μs exactly corresponding to the excitation duration. This results in the third control signal sk* depicted in FIG. 5b for control of the camera system 8 for taking the second fluorescent image FB2 in the fall phase AbP. The third control signal sk* is likewise a periodic square wave signal with an amplitude A. FIG. 5a again shows the first control signal sl provided for control of the light sources 7. Due to the phase shift, corresponding to the excitation duration, of ca. 100 μs between the first and third control signal sl, sk*, the taking of the second fluorescent image FB2 is started by means of the third control signal sk* receiving its amplitude A at the first time t1 and therefore the entire fall phase AbP of the fluorescence to the second time t2 is recorded.

The first and second fluorescent images FB1, FB2 generated by means of the depicted first through third control signal sl, sk, sk* are transmitted by the camera control module 3.3 to the computer unit 4, where they are analyzed by means of the control and analysis routine AAR. To determine the fluorescent intensities, the first and second intensity integral A1, A2 are determined based on the image data of the first and second fluorescent image FB1, FB2, which exists for example in digital form, and then the ratio R is calculated.

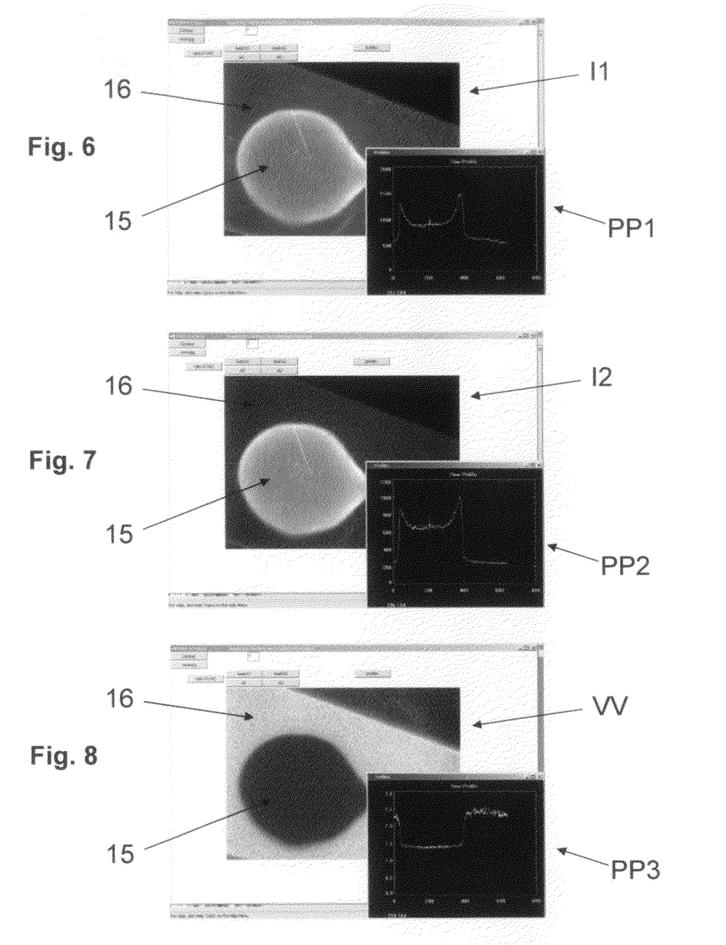

In the following, the method according to the invention is used to determine the oxygen partial pressure distribution of a droplet 15 of aqueous sodium sulfite solution in ambient air on a table surface. The determined fluorescent intensity distributions are shown in FIGS. 6 through 8, each based on an on-screen display and a profile plot PP1 through PP3. For this purpose, a planar oxygen sensor 16 in the form of a fluorescent optical sensor 10 is used. The droplet 15, as opposed to the ambient air, is more or less oxygen-free, since the oxygen contained in the aqueous solution in the form of sulfite (SO₃²⁻) oxidizes to sulfate (SO₄²⁻) and therefore escapes from the aqueous solution. The oxygen partial pressure difference between the droplet 15 and the ambient air is reflected by a changed fluorescent intensity and the corresponding fall behavior. The image is taken here under room lighting conditions.

According to the method described above a first and second fluorescent image FB1, FB2 was taken and transmitted to the computer unit 4 and the fluorescent intensity I1, I2 in the rise and fall phase AnP, AbP of the fluorescence and their ratio R were determined by means of the control and analysis routine AAR based on the first and second fluorescent images FB1, FB2, respectively, which exist in the form of digitalized images.

FIG. 6 shows a gray-scale depiction of the fluorescent intensity distribution 11 in the rise phase AnP of the fluorescence of the entire measuring range and in a first profile plot PP1 along a selected sectional plane through the measuring range. The first profile plot PP1 shows the measured gray-scale values of a horizontal data series from the middle range of the fluorescent intensity distribution I1. The fluorescent intensity distribution I1 clearly exhibits irregularities (e.g. the “11 o'clock line” within the droplet 15). The edges of the droplet 15 also exhibit a higher intensity, which is also visible through two peaks in the first profile plot PP1. However, this is not the result of a lower oxygen partial pressure, but instead is caused by the light guiding of the light within the droplet 15 and a more efficient extraction of the light on the droplet edges.

FIG. 7 shows the fluorescent intensity distribution 12 measured during the fall phase AbP with the corresponding second profile plot PP2. Essentially, the fluorescent intensity distribution 12 has the same structures as before, i.e. irregularities (e.g. the “11 o'clock line” within the droplet 15) of the planar oxygen sensor 16 are still visible in FIG. 7, however with different intensities.

FIG. 8 shows the ratio R of the two fluorescent intensity distributions 11, 12 based on a ratio distribution VV. Due to the ratio formation, all irregularities such as the so-called “11 o'clock line” and the maxima on the droplet edges have disappeared. The signal noise from the planar oxygen sensor 16 caused by the interfering effects is reduced significantly within the droplet 15 with a low oxygen partial pressure as compared with the higher partial oxygen pressure in the area surrounding the droplet. The described behavior of the fluorescent optical sensor 10 is particularly suitable for medical applications, since the oxygen partial pressure distributions to be found there frequently have an extremely low value. Also the gray-scale values of a horizontal data series through the ratio distribution VV in the third profile plot PP3, in particular the missing peaks on the droplet edges, exhibit a significant reduction of the interfering effects.

By taking additional normal images NB1-NB3 and superimposing said images with the first and second fluorescent images FB1, FB2 or their fluorescent intensity distributions 11, 12 and/or with the ratio distribution VV, the oxygen distribution in a tissue surface section 9 can be visualized together with the color image via the monitor unit 5, therefore making it considerably easier for a doctor, for example, to identify areas of the examined tissue surface section having an insufficient oxygen concentration.

The images are taken in this case preferably under room lighting conditions and/or in a live mode.

The invention was described above based on an exemplary embodiment. It goes without saying that numerous modifications and variations are possible without abandoning the underlying inventive idea on which the invention is based.

### REFERENCE LIST

1 measuring system

2 measuring head unit

3 control unit

3.1 light source control module

3.2 trigger signal unit

3.3 camera control module

4 computer unit

5 monitor unit

6 holding plate

7 light source(s)

8 camera system

9 tissue surface section

10 fluorescent optical sensor

11 CCD module

12 lens

13 excitation light

14 emission light

15 droplet

16 planar oxygen sensor

AAR control and analysis routine

A1 first intensity integral

A2 second intensity integral

d distance

FB1 first fluorescent image

FB2 second fluorescent image

I intensity of the fluorescence

Iₘₐₓ saturation value

I1, I2 fluorescent intensity distributions

NB1 first normal image

NB2 second normal image

NB3 third normal image

P1 first oxygen partial pressure

P2 second oxygen partial pressure

PP1 first profile plot

PP2 second profile plot

PP3 third profile plot

SL control lines

t1-t4 first-fourth time

ts trigger signal

VV ratio distribution

What is claimed is:

1. A method for determining the oxygen partial pressure distribution in at least one tissue surface section, wherein
a fluorescent dye is applied,
the fluorescent dye applied to the tissue surface section is impinged with excitation light in order to generate fluorescence,
in a rise phase (AnP) of the fluorescence, at least one first fluorescent image (FB1) is taken by means of a camera system and in a fall phase (AbP) of the fluorescence at least one second fluorescent image (FB2) is taken,
fluorescent intensities (A1, A2) in the rise phase (AnP) and the fall phase (AbP) are determined based on the first and second fluorescent images (FB1, FB2) taken and
by a ratio formation of the determined fluorescent intensities (A1, A2), the oxygen partial pressure distribution (P1, P2) in the at least one tissue surface section is determined.

2. The method according to claim 1, wherein to generate the fluorescence, pulsed excitation light is used, a spectrum of which in the UV range.

3. The method according to claim 2, wherein the pulsed excitation light is generated by means of a pulsed light source.

4. The method according to claim 1, wherein an excitation duration is selected to equal an exposure duration, the excitation duration being 100 μs and wherein a taking of the first and second fluorescent image (FB1, FB2) is controlled by means of a trigger signal (ts) and/or the first and second fluorescent images (FB1, FB2) are taken as digital image data in the rise and fall phase (AnP, AbP) and based on which the fluorescent intensities are determined as the first and second intensity integral (A1, A2).

5. The method according to claim 4, wherein a ratio (R) of the first intensity integral (A1) to the second intensity integral (A2) is determined and which is a measure for the oxygen partial pressure distribution (P1, P2) in the tissue surface section to be examined.

6. The method according to claim 1, wherein in addition to the fluorescent images (FB1, FB2) taken by means of the camera system, normal images (NB1-NB3) also are taken of the tissue surface section to be examined and/or wherein porphyrin is used as a fluorescent dye.

7. The method according to claim 6, wherein the exposure duration for the normal images is between 1 and 30 ms.

8. The method according to claim 1, wherein before application of the fluorescent dye to the tissue surface section to be examined, a transparent emulsion or a transparent special fluid is applied and/or wherein the intensity of the excitation light is controlled by means of the number of light sources designed as LEDs.

9. A measuring system for determining the oxygen partial pressure distribution in at least one tissue surface section,
having at least one fluorescent-optical sensor (10) comprising a fluorescent dye, the sensor is applied to the tissue surface section to be examined,
having at least one light source for generating excitation light, with which the fluorescent dye applied to the tissue surface section is impinged in order to generate fluorescence,
having at least one camera system for taking at least one first fluorescent image (FB1) in the rise phase (AnP) of the fluorescence and at least one second fluorescent image (FB2) in the fall phase (AbP) of the fluorescence,
having at least one control and analysis routine (AAR), by means of which the fluorescent intensities (A1, A2) in the rise and fall phase (AnP, AbP) are determined based on the first and second fluorescent images (FB1, FB2) taken and, by a ratio formation of the determined fluorescent intensities (A1, A2), the oxygen partial pressure distribution in the at least one tissue surface section is determined.

10. The measuring system according to claim 9, wherein the light source is as a pulsed light source and wherein the light source is an LED, flash lamp or laser diode.

11. The measuring system according to claim 9, wherein to increase an intensity of the excitation light, several light sources, or LEDs are provided.

12. The measuring system according to claim 11, wherein several light sources or LEDs form a light source group and several such light source groups are arranged symmetrically around the camera system.

13. The measuring system according to claim 9, wherein the fluorescent optical sensor is a planar sensor film or a micro-particle sensor and wherein the camera system is arranged perpendicular at a distance (d) of 3-15 cm above the tissue surface section to be measured and wherein the camera system is equipped with a charge-coupled device (CCD) module as an opto-electric image converter for taking fluorescent images (FB1, FB2) and normal images (NB1-NB3).

14. The measuring system according to claim 9, wherein for control of the at least one light source and the camera system, a control unit and a computer unit connected to said control unit are provided, and wherein the light source is a pulsed UV light source and in addition at least one pulsed normal light source is provided for lighting a measuring room for taking a normal image (NB1-NB3).

15. The measuring system according to claim 14, wherein the control unit comprises a trigger signal unit for generating a trigger signal (ts), by means of which simultaneous control of the light source and of the camera system takes place.
